(19) United States
(12) Patent Application Publication
(10) Pub. No.: US 2025/0202983 A1
(43) Pub. Date: Jun. 19, 2025

(54) MANAGEMENT APPARATUS AND CONTROL METHOD

(71) Applicant: Mitsubishi Electric Corporation, Tokyo (JP)

(72) Inventors: Taichi ISHIZAKA, Tokyo (JP); Koki OMATA, Tokyo (JP); Saki MIYAI, Tokyo (JP); Kanta MIYAMOTO, Tokyo (JP)

(21) Appl. No.: 18/846,344

(22) PCT Filed: Apr. 25, 2022
(86) PCT No.: PCT/JP2022/018742

§ 371 Date: Sep. 12, 2024

(51) Int. Cl. H04L 41/22; G06F 3/038

(52) U.S. Cl. CPC H04L 41/22; G06F 3/038

(57) ABSTRACT

A management apparatus includes: a display; a controller configured to control the display; and an address list including address information of a further management apparatus different from the management apparatus. The controller is configured to: communicate with the further management apparatus based on the address list, to obtain facility device data about a facility device managed by the further management apparatus; and cause the display to display the facility device data.

### TECHNICAL FIELD

The present disclosure relates to a management apparatus that manages a facility device, and a control method for a management apparatus.

### BACKGROUND ART

Japanese Patent Laying-Open No. 2002-71198 (PTL 1) discloses a system in which a floor management controller that manages facility devices such as air conditioners or lighting devices is placed in each floor of a building, and a building management controller that collectively manages the management controllers in the respective floors is placed, and further, a building management computer is communicably connected to the building management controller.

### CITATION LIST

### Patent Literature

PTL 1: Japanese Patent Laying-Open No. 2002-71198

### SUMMARY OF INVENTION

### Technical Problem

The system disclosed in Japanese Patent Laying-Open No. 2002-71198 causes the building management computer to have the function of a Web server, thereby allowing a user to view data of the facility devices through the Web server of the building management computer by using a Web browser executed on a general-purpose computer such as a personal computer (PC). As a result, using one PC, the user can view the data of the facility devices managed by each of the plurality of management apparatuses.

However, in the case of the system in which the general-purpose computer such as the PC is used, the user must always check whether the general-purpose computer is operating normally, and must also take security measures for the general-purpose computer. For example, when an operation PC for monitoring and operating the facility devices is placed in each floor of the building, a building manager must have a responsibility to always check whether the operation PC is operating normally, and also to take security measures for the operation PC. Therefore, it is not common to place the above-described operation PC in each floor, and a system in which monitorable and operable management apparatuses equipped with displays, which are sold by a facility device manufacturer, are placed on a wall surface and each user operates the management apparatuses is commonly used.

In the above-described system including the management apparatuses, a management apparatus serving as a master apparatus and a plurality of management apparatuses (or expansion adapters) serving as slave apparatuses are placed, and using the management apparatus serving as a master apparatus, the user can monitor facility devices managed by each of the plurality of management apparatuses serving as slave apparatuses.

Such management apparatuses are generally designed at low cost and exclusively for facility device management, and thus, are smaller in memory capacity and lower in processor processing performance than the general-purpose computer such as the PC. Due to the limitations on the memory capacity, the limitations on the processor processing capability and the like of the management apparatus serving as a master apparatus, the number of the management apparatuses serving as slave apparatuses that can be connected to one management apparatus serving as a master apparatus is also limited. Therefore, in a building where a large number of facility devices are placed, it is necessary to increase the number of the management apparatus serving as a master apparatus, and thus, the user must check the plurality of management apparatuses serving as master apparatuses, which causes a workload.

Essentially, it is ideal that the user can monitor the facility devices using one management apparatus in each floor, and that the manager can also monitor all of the facility devices in the building using one management apparatus in a manager's room. However, the correspondence relationship between the master apparatus and the slave apparatus is fixed and there are limitations on the number of connectable management apparatuses. Furthermore, the management apparatus serving as a slave apparatus can monitor the facility devices managed by the management apparatus itself, whereas the management apparatus serving as a slave apparatus cannot monitor the facility devices managed by another management apparatus serving as a slave apparatus. Therefore, it is necessary to place a plurality of management apparatuses in each floor and the manager's room. This may cause such an inconvenience that the user does not know which management apparatus the user should use when operating the facility device to be monitored, or such an inconvenience that the manager must check all of the plurality of management apparatuses every time.

The present disclosure has been made to solve the above-described problem, and an object thereof is to provide a technique by which a facility device managed by another management apparatus can be monitored using one management apparatus, without considering the limitations on the number of connectable management apparatuses.

### Solution to Problem

A management apparatus according to the present disclosure is a management apparatus that manages a facility device. The management apparatus includes: a display; a controller configured to control the display; and an address list including address information of a further management apparatus different from the management apparatus. The controller is configured to: communicate with the further management apparatus based on the address list, to obtain facility device data about the facility device managed by the further management apparatus; and cause the display to display the facility device data.

A control method according to the present disclosure is a control method for a management apparatus that manages a facility device. The control method includes: communicating with a further management apparatus different from the management apparatus based on an address list including address information of the further management apparatus, to obtain facility device data about the facility device managed by the further management apparatus; and causing a display of the management apparatus to display the facility device data.

### Advantageous Effects of Invention

According to the present disclosure, the management apparatus can communicate with the further management apparatus based on the address list, to obtain the facility device data about the facility device managed by the further management apparatus, and cause the display to display the facility device data. Therefore, the facility device managed by the other management apparatus can be monitored, without considering the limitations on the number of connectable management apparatuses.

### BRIEF DESCRIPTION OF DRAWINGS

FIG. 1 is a diagram showing a configuration of a management system according to an embodiment.

FIG. 2 is a diagram showing a configuration of a management apparatus according to the embodiment.

FIG. 3 is a diagram showing an example of an address list included in the management apparatus according to the embodiment.

FIG. 4 is a flowchart for a monitoring screen display process performed by the management apparatus according to the embodiment.

FIG. 5 is a sequence diagram for a process performed between the management apparatus according to the embodiment and another management apparatus.

FIG. 6 is a flowchart for a transmission-side operation state change process performed by the management apparatus according to the embodiment.

FIG. 7 is a flowchart for a reception-side operation state change process performed by the management apparatus according to the embodiment.

FIG. 8 is a flowchart for a past operation data viewing process performed by the management apparatus according to the embodiment.

### DESCRIPTION OF EMBODIMENTS

Embodiments of the present disclosure will be described in detail hereinafter with reference to the drawings. Although a plurality of embodiments will be described below, it is originally intended to combine features described in the embodiments as appropriate. In the drawings, the same or corresponding portions are denoted by the same reference characters and description thereof will not be repeated.

### [Configuration of Management System]

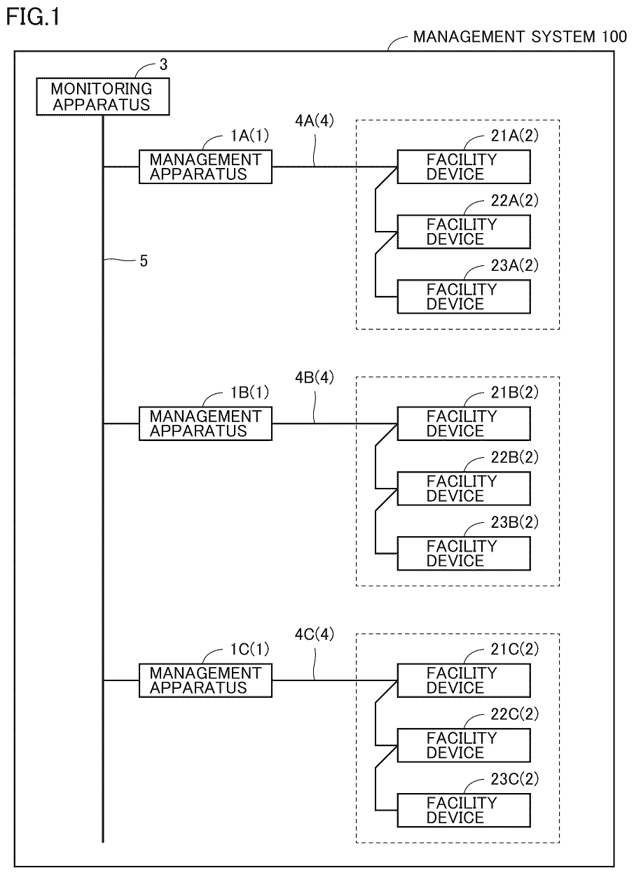

FIG. 1 is a diagram showing a configuration of a management system 100 according to an embodiment. As shown in FIG. 1, management system 100 includes a plurality of facility devices 2, a plurality of management apparatuses 1 that manage facility devices 2, and a monitoring apparatus 3 that monitors the plurality of facility devices 2 through the plurality of management apparatuses 1.

In FIG. 1, management apparatuses 1A, 1B and 1C are illustrated as the plurality of management apparatuses 1. Each of management apparatuses 1A, 1B and 1C is a system controller that controls a system including facility devices 2 such as air conditioners, lighting devices or water heaters. Since management apparatuses 1A, 1B and 1C each have the same configuration, management apparatuses 1A, 1B and 1C can operate using a common program. Management apparatuses 1A, 1B and 1C are also collectively referred to as management apparatus 1. In addition, in FIG. 1, facility devices 21A, 22A, 23A, 21B, 22B, 23B, 21C, 22C, and 23C are illustrated as the plurality of facility devices 2. Facility devices 21A, 22A, 23A, 21B, 22B, 23B, 21C, 22C, and 23C each have the same configuration and these are also collectively referred to as facility device 2.

Management apparatus 1A is communicably connected to each of the plurality of facility devices 21A, 22A and 23A through a communication line 4A. Management apparatus 1B is communicably connected to each of the plurality of facility devices 21B, 22B and 23B through a communication line 4B. Management apparatus 1C is communicably connected to each of the plurality of facility devices 21C, 22C and 23C through a communication line 4C. Each of management apparatuses 1A, 1B and 1C is not limited to being connected to the plurality of facility devices 2, but may be connected to at least one facility device 2. Communication lines 4A, 4B and 4C each have the same configuration and these are also collectively referred to as communication line 4.

Monitoring apparatus 3 is communicably connected to each of the plurality of management apparatuses 1A, 1B and 1C through a communication line 5. Furthermore, the plurality of management apparatuses 1A, 1B and 1C are communicably connected to each other through communication line 5.

Facility device 2 is, for example, an air conditioner, a lighting device or a water heater placed in a building. Facility device 2 can be operated by a user, and data thereof such as an operation state can be viewed by the user. Each facility device 2 operates based on control by connected management apparatus 1. Facility device data indicating the operation state or the like of each facility device 2 is transmitted to management apparatus 1 through communication line 4.

In management system 100 configured as described above, each management apparatus 1 can monitor the operation state of facility device 2 managed by management apparatus 1 itself, and can control facility device 2 based on a user's input.

Here, a case in which one management apparatus 1 of the plurality of management apparatuses 1 serves as a master apparatus and the remaining management apparatuses 1 serve as slave apparatuses is assumed. In this case, using management apparatus 1 serving as a master apparatus, the user can monitor facility devices 2 managed by each of the plurality of management apparatuses 1 serving as slave apparatuses. However, due to the limitations on the memory capacity, the limitations on the processor processing capability and the like of management apparatus 1 serving as a master apparatus, the number of management apparatuses 1 serving as slave apparatuses that can be connected to one management apparatus 1 serving as a master apparatus may also be limited.

For example, when facility devices 2 managed by the plurality of management apparatuses 1 serving as slave apparatuses are monitored using one management apparatus 1 serving as a master apparatus, management apparatus 1 serving as a master apparatus needs to manage and hold various types of data such as a current operation state, a past operation state, the occurrence of an abnormality, a recovery history, and an operation history of each facility device 2 in order to monitor or control the operation state of each facility device 2. Therefore, due to the limitations on the memory capacity, the limitations on the processor processing capability and the like, the number of management apparatuses 1 serving as slave apparatuses that can be connected to one management apparatus 1 serving as a master apparatus is limited to, for example, four at the maximum.

As a further example, when one management apparatus 1 can manage 50 facility devices 2 and up to four management apparatuses 1 serving as slave apparatuses can be connected to management apparatus 1 serving as a master apparatus in a five-story building where 100 facility devices 2 are placed in each floor, two management apparatuses 1 serving as slave apparatuses are placed in each floor and a total of 10 management apparatuses 1 serving as slave apparatuses are placed in the five floors. In this case, three management apparatuses 1 serving as master apparatuses are required. As described above, in a building where a large number of facility devices 2 are placed, it is necessary to increase the number of management apparatuses 1 serving as master apparatuses, and thus, the user must check the plurality of management apparatuses 1 serving as master apparatuses, which causes a workload.

Essentially, it is ideal that the user can monitor facility devices 2 using one management apparatus 1 in each floor, and that a manager can also monitor all of facility devices 2 in the building using one management apparatus 1 in a manager's room. However, as described above, the correspondence relationship between the master apparatus and the slave apparatus is fixed and there are limitations on the number of connectable management apparatuses. Therefore, it is necessary to place a plurality of management apparatuses 1 in each floor and the manager's room. This may cause such an inconvenience that the user does not know which management apparatus 1 the user should use when operating facility device 2 to be monitored, or such an inconvenience that the manager must check all of the plurality of management apparatuses 1 every time. Thus, management system 100 according to the embodiment is configured such that facility device 2 managed by another management apparatus 1 is monitored using one management apparatus 1, without considering the limitations on the number of connectable management apparatuses 1. Management apparatus 1 according to the embodiment will be specifically described below.

### [Configuration of Management Apparatus]

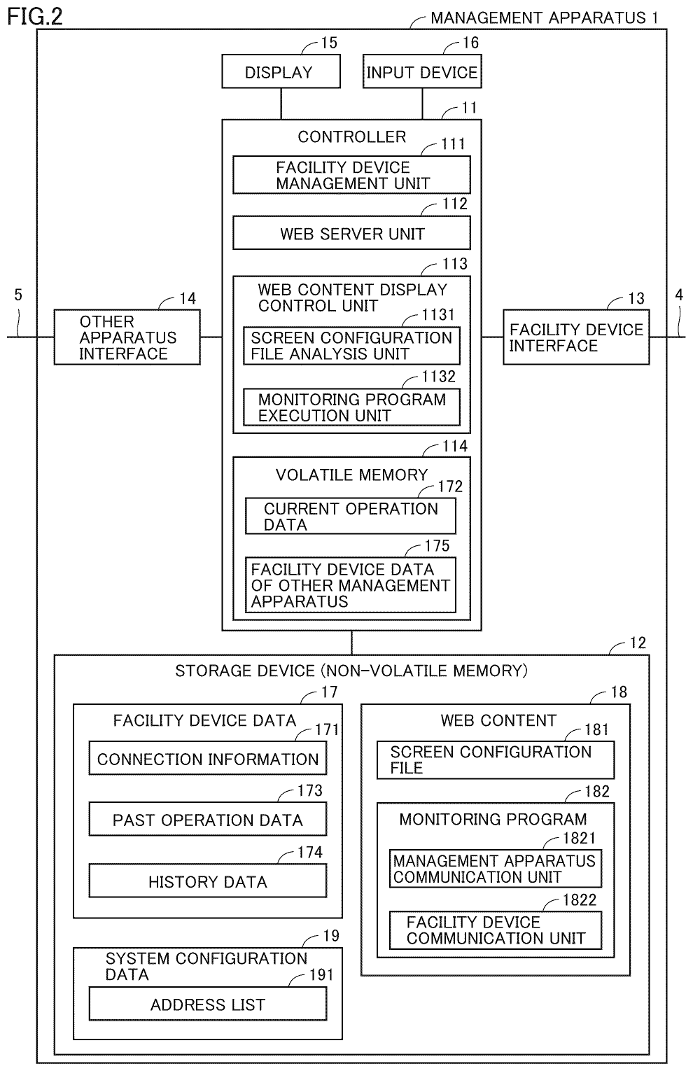

FIG. 2 is a diagram showing a configuration of management apparatus 1 according to the embodiment. Hereinafter, management apparatus 1 different from management apparatus 1 shown in FIG. 2 will also be referred to as “other management apparatus 1”. Other management apparatus 1 is an example of “further management apparatus”. As shown in FIG. 2, management apparatus 1 includes a controller 11, a storage device 12, a facility device interface 13, an other apparatus interface 14, a display 15, and an input device 16.

Facility device interface 13 is an interface that communicably connects controller 11 and facility device 2 through communication line 4. Controller 11 receives and transmits data to and from facility device 2 managed by management apparatus 1 through facility device interface 13. Communication line 4 may be a communication line dedicated to management apparatus 1, or may be a general-purpose communication line such as an interface for a local area network (LAN) or serial communication.

Other apparatus interface 14 is an interface that communicably connects controller 11 and each of other management apparatus 1 and monitoring apparatus 3 through communication line 5. Controller 11 receives and transmits data to and from other management apparatus 1 or monitoring apparatus 3 through other apparatus interface 14. Communication line 5 is, for example, a LAN (local area network) or a wireless LAN connected in the same building. Communication line 5 may be an internet line or the like that communicably connects the plurality of management apparatuses 1 to each other through a broadband router.

Display 15 displays the received data on a display screen based on control by controller 11. For example, by loading a Web content 18 with a Web browser executed by a Web content display control unit 113, display 15 displays a monitoring screen for viewing facility device data 17 of facility device 2 managed by management apparatus 1 itself or facility device data 175 of facility device 2 managed by other management apparatus 1, or operating facility device 2 managed by management apparatus 1 itself or facility device 2 managed by other management apparatus 1. The Web browser is stored in storage device 12, for example. A touch-operable touch panel may be attached to the display screen of display 15.

Input device 16 is an input device such as a mouse, a keyboard or a touch panel, and receives a user's input and transmits the input data to controller 11. Input device 16 may be a touch panel attached to the display screen of display 15, and display 15 may switch the screen based on the user's input.

Controller 11 is a computing entity (computer) that performs various types of processes in accordance with various types of programs. Controller 11 includes, for example, at least one of a central processing unit (CPU), a field programmable gate array (FPGA), a graphics processing unit (GPU), and a multi processing unit (MPU). Controller 11 may be implemented by processing circuitry.

Controller 11 includes, as its main functional configuration, a facility device management unit 111, a Web server unit 112, Web content display control unit 113, and a volatile memory 114.

Facility device management unit 111 manages facility device 2 connected by communication line 4 through facility device interface 13. Specifically, facility device management unit 111 performs a process for monitoring an operation state of facility device 2 or controlling facility device 2.

Web server unit 112 transmits Web content 18 stored in storage device 12 to Web content display control unit 113 in response to a request from Web content display control unit 113.

Web server unit 112 performs a process for receiving and transmitting data, based on various types of commands such as a viewing command to view facility device data 17, an operation command to operate facility device 2, and a setting command to set connection information 171 that are input by the user using input device 16. Furthermore, Web server unit 112 performs a process for receiving and transmitting data, based on various types of commands such as a viewing command to view facility device data 17, an operation command to operate facility device 2, and a setting command to set connection information 171 that are received from other management apparatus 1 connected by communication line 5 through other apparatus interface 14.

Specifically, when Web server unit 112 receives the viewing command, Web server unit 112 obtains data specified by the viewing command from facility device data 17, and provides, to facility device management unit 111, a display instruction to cause display 15 to display the obtained data. Based on the display instruction from Web server unit 112, facility device management unit 111 causes display 15 to display facility device data 17. When Web server unit 112 receives the viewing command from other management apparatus 1, Web server unit 112 obtains data specified by the viewing command from facility device data 17, and transmits the obtained data to other management apparatus 1 through other apparatus interface 14. Other management apparatus 1 causes its own display 15 to display the data received from management apparatus 1.

When Web server unit 112 receives the operation command, Web server unit 112 provides, to facility device management unit 111, an operation instruction to operate facility device 2. Based on the operation instruction from Web server unit 112, facility device management unit 111 causes facility device 2 to operate.

When Web server unit 112 receives the setting command to set connection information 171 such as an address number, an operation group number and identification information of facility device 2 managed by facility device management unit 111, Web server unit 112 provides, to facility device management unit 111, a setting instruction to set connection information 171. Based on the setting instruction from Web server unit 112, facility device management unit 111 sets connection information 171 stored in storage device 12.

Web content display control unit 113 performs a process for causing display 15 to display the monitoring screen for facility device 2, using Web content 18 obtained through Web server unit 112. Web content display control unit 113 includes a screen configuration file analysis unit 1131 and a monitoring program execution unit 1132.

Screen configuration file analysis unit 1131 analyzes a screen configuration file 181 obtained through Web server unit 112.

Monitoring program execution unit 1132 executes a monitoring program 182 obtained through Web server unit 112.

Volatile memory 114 is a volatile storage unit such as a dynamic random access memory (DRAM) or a static random access memory (SRAM). Volatile memory 114 temporarily stores current operation data 172 indicating the current operation state of facility device 2 managed by management apparatus 1 itself, and facility device data 175 about facility device 2 managed by other management apparatus 1.

Current operation data 172 includes data indicating the current operation state of facility device 2 managed by facility device management unit 111 of management apparatus 1 itself. For example, when facility device 2 is an air conditioner, current operation data 172 includes various types of data indicating the current operation state, such as an operation state or an out-of-operation state of the air conditioner, an operation mode such as cooling or heating, a set temperature, and an indoor temperature. In the first embodiment, current operation data 172 may be included in a part of facility device data 17 described below. Controller 11 of management apparatus 1 receives and transmits data to and from facility device 2, thereby updating current operation data 172 to a latest state whenever necessary.

Storage device 12 is a non-volatile storage unit such as a hard disk drive (HDD), a solid state drive (SSD), a read only memory (ROM), or a flash memory, and stores various types of data that allows controller 11 to monitor and control facility device 2. Storage device 12 includes facility device data 17, Web content 18 and system configuration data 19.

Facility device data 17 includes connection information 171, past operation data 173 and history data 174. As described above, facility device data 17 also includes current operation data 172 temporarily stored in volatile memory 114.

Connection information 171 includes data for controlling facility device 2, such as the address number, the operation group number and the identification information of facility device 2 managed by facility device management unit 111.

Past operation data 173 includes data indicating a past operation state of facility device 2 managed by facility device management unit 111. For example, when facility device 2 is an air conditioner, past operation data 173 includes various types of data indicating the past operation state, such as an operation state or an out-of-operation state of the air conditioner, an operation mode such as cooling or heating, a set temperature, and an indoor temperature. Furthermore, past operation data 173 includes an ON state or an OFF state of a thermometer used for charging apportionment or analysis of energy usage status, information about a degree of opening of a linear expansion valve (LEV) indicating a flow rate of refrigerant, and pressure information or temperature information of each unit in a refrigerant circuit, and the like. Controller 11 of management apparatus 1 accumulates and stores past operation data 173 periodically (e.g., at one-minute intervals).

History data 174 includes various types of data such as the occurrence of an abnormality, a recovery history or an operation history of facility device 2 managed by facility device management unit 111.

Web content 18 includes screen configuration file 181 and monitoring program 182.

Screen configuration file 181 includes a data file describing a layout configuration of a screen displayed on display 15, and various image files. For example, screen configuration file 181 includes a hypertext markup language (HTML) file describing a frame configuration, a cascading style sheets (CSS) file defining the display appearance, and the like. Screen configuration file 181 also includes various image files described in graphics interchange format (GIF) format, in joint photographic experts group (JPEG) format, in Bitmap (BMP) format or the like. Screen configuration file 181 is stored in storage device 12 (e.g., the ROM) at the time of shipment of management apparatus 1.

Monitoring program 182 is a program executed on the Web browser to perform various types of communication processes and screen display processes. Monitoring program 182 has a source code described thereon using a known programming language such as JavaScript (registered trademark), for example. Monitoring program 182 is transmitted to Web content display control unit 113 through Web server unit 112 and is executed on the Web browser by monitoring program execution unit 1132 of Web content display control unit 113.

For example, monitoring program 182 has described thereon a process for obtaining facility device data 17 and 175 of facility devices 2 managed by management apparatus 1 and other management apparatus 1, and holding obtained facility device data 17 and 175 in storage device 12 or volatile memory 114 and causing display 15 to display obtained facility device data 17 and 175.

Monitoring program 182 includes, as its main processing units, a management apparatus communication unit 1821 and a facility device communication unit 1822.

Management apparatus communication unit 1821 performs a process for communicating with Web server unit 112 of management apparatus 1, and a process for communicating with Web server unit 112 of other management apparatus 1.

Facility device communication unit 1822 performs a process for obtaining facility device data 17 and 175 of facility devices 2 managed by management apparatus 1 and other management apparatus 1, and holding obtained facility device data 17 and 175 in storage device 12 or volatile memory 114.

System configuration data 19 includes an address list 191. Address list 191 includes address information of other management apparatus 1 connected to controller 11 through other apparatus interface 14. Furthermore, address list 191 may also include address information of management apparatus 1 itself. That is, address list 191 may include the address information of other management apparatus 1 and the address information of management apparatus 1 itself, or may include only the address information of other management apparatus 1. Address list 191 may include only the address information of management apparatus 1 itself.

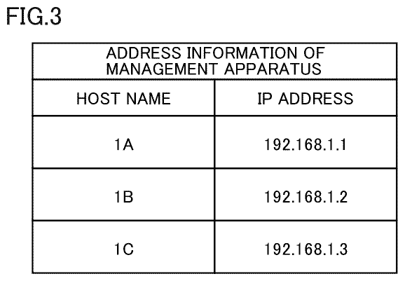

FIG. 3 is a diagram showing an example of address list 191 included in management apparatus 1 according to the embodiment. As shown in FIG. 3, address list 191 includes a host name and an internet protocol (IP) address as address information that can specify a connection destination. Furthermore, address list 191 includes not only the address information of other management apparatus 1 but also the address information of management apparatus 1 itself.

For example, in the example shown in FIG. 3, as the address information of management apparatus 1A that is management apparatus 1 itself, address list 191 includes the host name “1A” of management apparatus 1A, and the IP address. As the address information of management apparatus 1B that is other management apparatus 1, address list 191 includes the host name “1B” of management apparatus 1B, and the IP address. As the address information of management apparatus 1C that is other management apparatus 1, address list 191 includes the host name “1C” of management apparatus 1C, and the IP address. Address list 191 may include a domain name of other management apparatus 1 as the address information of other management apparatus 1, or may include a domain name of management apparatus 1 itself as the address information of management apparatus 1 itself.

Controller 11 of management apparatus 1 communicates with other management apparatus 1 based on address list 191, to obtain facility device data 175 about facility device 2 managed by other management apparatus 1, and causes display 15 to display obtained facility device data 175.

For example, controller 11 of management apparatus 1A communicates with other management apparatuses 1B and 1C based on the address information of other management apparatuses 1B and 1C included in address list 191, and obtains, through other apparatus interface 14, facility device data 175 about facility devices 2 managed by other management apparatuses 1B and 1C. Controller 11 stores, in volatile memory 114, obtained facility device data 175 about facility devices 2 managed by other management apparatuses 1B and 1C. Controller 11 causes display 15 to display facility device data 175 stored in volatile memory 114 on the monitoring screen of display 15.

Thus, management apparatus 1A can obtain facility device data 175 about facility devices 2 managed by other management apparatuses 1B and 1C based on address list 191, and cause display 15 to display obtained facility device data 175 on the monitoring screen of display 15. Therefore, management apparatus 1A itself does not need to store and hold facility device data 175 about facility devices 2 managed by other management apparatuses 1B and 1C in storage device 12. Furthermore, facility device data 175 about facility devices 2 managed by other management apparatuses 1B and 1C, which is stored in volatile memory 114, is erased when power supply is interrupted due to power-off or the like. Therefore, management apparatus 1A can monitor facility devices 2 managed by other management apparatuses 1B and 1C, without considering the limitations on the number of connectable management apparatuses 1.

In addition, when the address information of management apparatus 1A itself is included in address list 191, controller 11 of management apparatus 1A obtains facility device data 17 about facility device 2 managed by management apparatus 1A from facility device 2. Controller 11 causes display 15 to display obtained facility device data 17 on the monitoring screen of display 15.

Thus, management apparatus 1A can also obtain facility device data 17 about facility device 2 managed by management apparatus 1A itself based on address list 191, and cause display 15 to display obtained facility device data 17.

Furthermore, controller 11 of management apparatus 1A communicates with other management apparatuses 1B and 1C based on the address information of other management apparatuses 1B and 1C included in address list 191, and transmits a control signal for controlling facility devices 2 managed by other management apparatuses 1B and 1C to other management apparatuses 1B and 1C based on the user's input received by input device 16. Based on the control signal from management apparatus 1A, other management apparatuses 1B and 1C cause facility devices 2 managed by other management apparatuses 1B and 1C to operate.

Thus, using one management apparatus 1A, the user can control facility devices 2 managed by other management apparatuses 1B and 1C, which leads to improvement in user convenience.

In order to ensure the security when management apparatus 1 obtains facility device data 175 of other management apparatus 1, all of management apparatuses 1 may hold a common first certificate (root certificate) and each management apparatus 1 may hold a second certificate (intermediate root certificate) and a third certificate (server certificate) that are different from each other. These second certificate (intermediate root certificate) and third certificate (server certificate) may be incorporated into each management apparatus 1 during shipping inspection. As a verification method, management apparatus 1 may verify whether the second and third certificates obtained from other management apparatus 1 have been generated using the first certificate held by management apparatus 1 itself at the time of transport layer security (TLS) connection, thereby preventing connection destination spoofing and the like. That is, management apparatus 1 may be configured to be connectable to other management apparatus 1 on the condition that the second and third certificates held by other management apparatus 1 to which management apparatus 1 is to be connected have been generated using the first certificate held by management apparatus 1 itself. In this case, simply by holding the common first certificate (root certificate) and address list 191, management apparatus 1 can achieve communication connection with the ensured security.

### [Monitoring Screen Display Process]

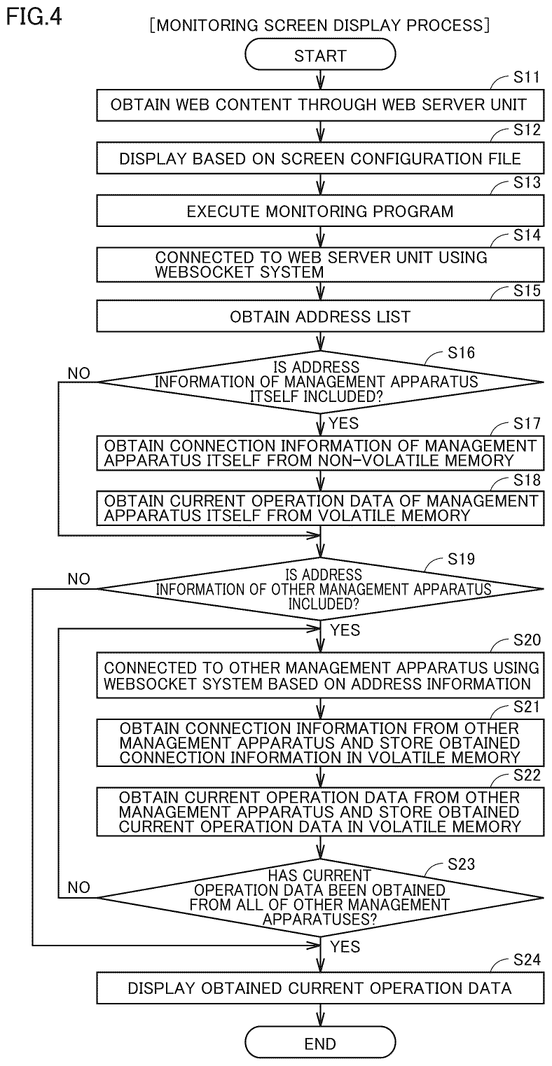

FIG. 4 is a flowchart for a monitoring screen display process performed by management apparatus 1 according to the embodiment. The process shown in FIG. 4 is performed by the processing units of facility device management unit 111, Web server unit 112 and Web content display control unit 113 included in controller 11 of management apparatus 1. In addition, the process shown in FIG. 4 may be performed when management apparatus 1 is powered on and power supply to controller 11 is started, or may be performed when a start command is input by the user using input device 16. In FIG. 4, “S” is used as an abbreviation for “STEP”.

As shown in FIG. 4, controller 11 obtains Web content 18 through Web server unit 112 (S11). Specifically, Web content display control unit 113 specifies its own uniform resource locator (URL) and executes the Web browser, thereby starting connection with Web server unit 112 using a hypertext transfer protocol (HTTP) protocol or a transport layer security (TLS) protocol, and obtains Web content 18 stored in storage device 12 through Web server unit 112.

When the Web browser is executed, controller 11 may cause display 15 to display a login screen that requests login information such as an ID and a password for the user. In this case, when the user inputs the correct login information using input device 16, controller 11 may display the monitoring screen and perform the processing in S11 and the subsequent steps. Alternatively, when the Web browser is executed, controller 11 may automatically log in using parameter authentication information prepared preliminarily by Web content display control unit 113. As a result, the user can save time and effort required to input the correct login information using input device 16.

Controller 11 causes display 15 to display the monitoring screen based on screen configuration file 181 (S12). Specifically, screen configuration file analysis unit 1131 analyzes screen configuration file 181 included in obtained Web content 18, and causes display 15 to display the monitoring screen in accordance with the HTML file specified by the URL. In this way, Web content display control unit 113 can cause display 15 to display the monitoring screen by loading Web content 18 with the Web browser.

Controller 11 executes monitoring program 182 (S13). Specifically, monitoring program execution unit 1132 executes monitoring program 182 included in obtained Web content 18.

Web content display control unit 113 is connected to Web server unit 112 using a WebSocket system (S14). The WebSocket system is a technical standard for bidirectional communication between a Web server and a Web client. Unlike connection using the HTTP protocol, connection using the WebSocket system allows constant connection between the Web server and the Web client. Therefore, when communication is required, data transmission can be started from any of the Web server and the Web client. That is, by constant connection between Web server unit 112 corresponding to the Web server and Web content display control unit 113 corresponding to the Web client using the WebSocket system, data transmission can be started from any of Web server unit 112 and Web content display control unit 113.

Controller 11 obtains address list 191 stored in storage device 12 (S15). Specifically, Web content display control unit 113 obtains address list 191 stored in storage device 12, through Web server unit 112 connected using the WebSocket system. Controller 11 determines whether the address information of management apparatus 1 itself is included in address list 191 (S16).

When the address information of management apparatus 1 itself is included in address list 191 (YES in S16), controller 11 obtains connection information 171 of management apparatus 1 itself from storage device 12 serving as a non-volatile memory (S17). Based on connection information 171, controller 11 obtains, from volatile memory 114, current operation data 172 of facility device 2 managed by management apparatus 1 (S18).

When the address information of management apparatus 1 itself is not included in address list 191 (NO in S16), or after the processing in S18, controller 11 determines whether the address information of other management apparatus 1 is included in address list 191 (S19).

When the address information of other management apparatus 1 is included in address list 191 (YES in S19), controller 11 is connected to other management apparatus 1 using the WebSocket system based on the address information included in address list 191 (S20). Specifically, Web content display control unit 113 specifies a communication destination based on the address information included in address list 191, and is connected to other management apparatus 1 using the WebSocket system. As a result, controller 11 can be constantly connected to other management apparatus 1 by bidirectional communication based on address list 191.

Controller 11 obtains connection information 171 from other management apparatus 1 that is being connected using the WebSocket system, and stores obtained connection information 171 in volatile memory 114 (S21).

Based on connection information 171 obtained from other management apparatus 1, controller 11 obtains current operation data 172 from other management apparatus 1 that is being connected using the WebSocket system, and stores obtained current operation data 172 in volatile memory 114 (S22). In this way, controller 11 stores, in volatile memory 114, current operation data 172 of facility device 2 managed by other management apparatus 1, which is to be displayed on the monitoring screen of display 15.

Controller 11 determines whether controller 11 has obtained current operation data 172 from all of other management apparatuses 1 (S23).

When controller 11 has not obtained current operation data 172 from all of other management apparatuses 1 (NO in S23), the process returns to S20 and controller 11 is connected to not-yet-connected other management apparatus 1 using the WebSocket system based on the address information included in address list 191, and obtains current operation data 172 from other management apparatus 1.

When controller 11 has obtained current operation data 172 from all of other management apparatuses 1 (YES in S23), or when the address information of other management apparatus 1 is not included in address list 191 (NO in S19), controller 11 causes display 15 to display obtained current operation data 172 on the monitoring screen of display 15 (S24).

For example, when controller 11 obtains current operation data 172 of management apparatus 1 itself in S18, controller 11 causes display 15 to display an icon image indicating obtained current operation data 172 of management apparatus 1 itself. Furthermore, when controller 11 obtains current operation data 172 of other management apparatus 1 in S22, controller 11 causes display 15 to display an icon image indicating obtained current operation data 172 of other management apparatus 1. That is, based on the user's input received by input device 16, controller 11 can cause display 15 to display the icon image indicating current operation data 172 specified by the user, of current operation data 172 of management apparatus 1 itself and current operation data 172 of other management apparatus 1 that are stored in volatile memory 114. Thereafter, controller 11 ends this process.

As described above, by performing the monitoring screen display process, controller 11 can obtain current operation data 172 of facility device 2 managed by other management apparatus 1 based on address list 191 and temporarily store obtained current operation data 172 in volatile memory 114, and can cause display 15 to display current operation data 172 temporarily stored in volatile memory 114 on the monitoring screen of display 15. Thus, management apparatus 1 itself does not need to store and hold facility device data 175 about facility device 2 managed by other management apparatus 1 in non-volatile storage device 12. Therefore, a shortage of the memory capacity of storage device 12 can be avoided and there is no need to consider the limitations on the number of connectable management apparatuses 1.

Management apparatus 1 can cause display 15 to display, in a mixed manner, facility device data 17 and 175 of facility devices 2 managed by the plurality of management apparatuses 1 including management apparatus 1 itself and other management apparatus 1. Thus, management problems such as an abnormality of facility device 2 and powering off facility device 2 (e.g., forgetting to turn off a lighting device as facility device 2) can be solved more easily, as compared with the case in which each management apparatus 1 causes display 15 to display only facility device data 17 of facility device 2 managed by management apparatus 1 itself.

In the monitoring screen display process shown in FIG. 4, controller 11 obtains current operation data 172 and causes display 15 to display obtained current operation data 172. However, the monitoring screen display process shown in FIG. 4 is also applicable to a case in which controller 11 obtains past operation data 173 or history data 174 and causes display 15 to display obtained past operation data 173 or history data 174, similarly to current operation data 172.

That is, by performing the monitoring screen display process, controller 11 can obtain facility device data 175 including current operation data 172, past operation data 173 and history data 174 of facility device 2 managed by other management apparatus 1 based on address list 191 and cause display 15 to display obtained facility device data 175 on the monitoring screen of display 15, and can cause display 15 to display facility device data 17 including current operation data 172, past operation data 173 and history data 174 of facility device 2 managed by management apparatus 1 itself on the monitoring screen of display 15.

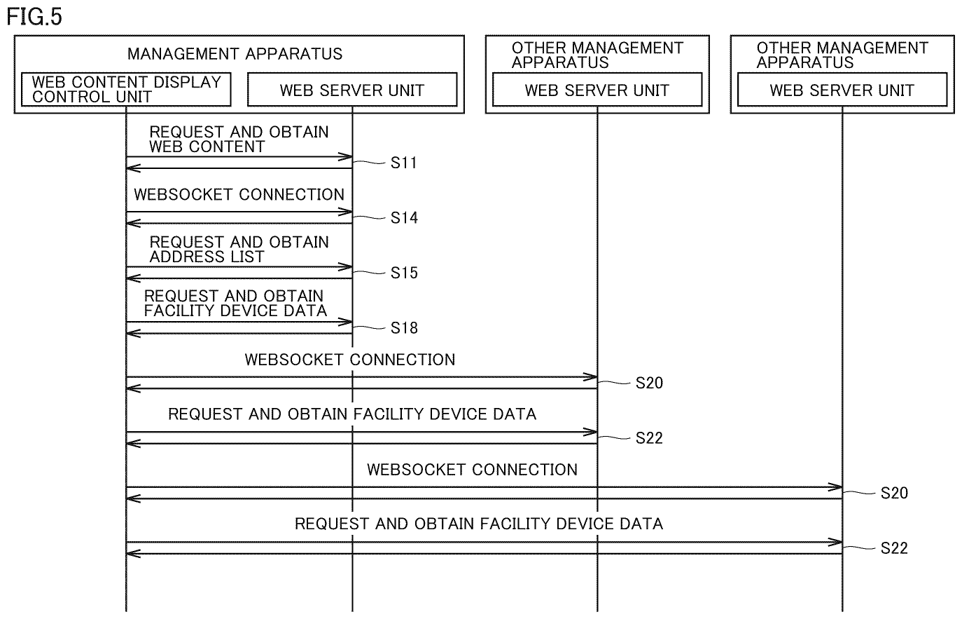

FIG. 5 is a sequence diagram for a process performed between management apparatus 1 and other management apparatus 1 according to the embodiment. FIG. 5 shows the sequence diagram for the process performed between management apparatus 1 and other management apparatus 1 when management apparatus 1 performs the monitoring screen display process shown in FIG. 4.

As shown in FIG. 5, in management apparatus 1, Web content display control unit 113 executes the Web browser, thereby starting connection with Web server unit 112, and requests Web content 18 for Web server unit 112. In response to the request from Web content display control unit 113, Web server unit 112 transmits Web content 18 stored in storage device 12 to Web content display control unit 113. Web content display control unit 113 thus obtains Web content 18 through Web server unit 112. This processing corresponds to the processing in S11 of FIG. 4.

Web content display control unit 113 executes monitoring program 182 included in Web content 18 and is connected to Web server unit 112 using the WebSocket system. This processing corresponds to the processing in S14 of FIG. 4.

Web content display control unit 113 requests address list 191 for Web server unit 112 connected using the WebSocket system. In response to the request from Web content display control unit 113, Web server unit 112 transmits address list 191 stored in storage device 12 to Web content display control unit 113. Web content display control unit 113 thus obtains address list 191 through Web server unit 112. This processing corresponds to the processing in S15 of FIG. 4.

When the address information of management apparatus 1 itself is included in address list 191, Web content display control unit 113 requests facility device data 17 for Web server unit 112 connected using the WebSocket system. In response to the request from Web content display control unit 113, Web server unit 112 transmits facility device data 17 stored in volatile memory 114 or storage device 12 to Web content display control unit 113. Web content display control unit 113 thus obtains facility device data 17 through Web server unit 112. This processing corresponds to the processing in S18 of FIG. 4.

Web content display control unit 113 specifies a communication destination based on the address information included in address list 191, and is connected to other management apparatus 1 using the WebSocket system. This processing corresponds to the processing in S20 of FIG. 4.

Web content display control unit 113 requests facility device data 175 for other management apparatus 1 that is being connected using the WebSocket system. In response to the request from management apparatus 1, Web server unit 112 of other management apparatus 1 transmits facility device data 175 to management apparatus 1. Management apparatus 1 thus obtains facility device data 175 from other management apparatus 1. This processing corresponds to the processing in S22 of FIG. 4.

When address information of not-yet-connected other management apparatus 1 is included in address list 191, Web content display control unit 113 specifies a not-connected communication destination based on the address information and is connected to other management apparatus 1 using the WebSocket system. This processing corresponds to the processing in S20 of FIG. 4.

Web content display control unit 113 requests facility device data 175 for other management apparatus 1 that is being connected using the WebSocket system. In response to the request from management apparatus 1, Web server unit 112 of other management apparatus 1 transmits facility device data 175 to management apparatus 1. Management apparatus 1 thus obtains facility device data 175 from other management apparatus 1. This processing corresponds to the processing in S22 of FIG. 4.

By repeatedly performing the above-described processing in S20 and S22, management apparatus 1 can obtain facility device data 175 from other management apparatus 1 corresponding to the address information included in address list 191, and temporarily store obtained facility device data 175 in volatile memory 114.

### [Operation State Change Process]

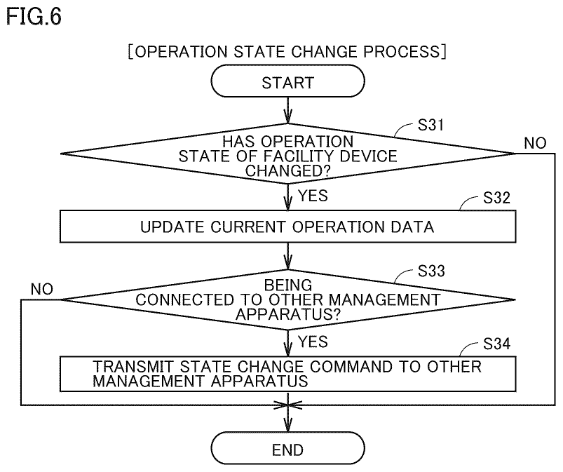

A process when management apparatus 1 notifies other management apparatus 1 that the operation state of facility device 2 has changed will be described. FIG. 6 is a flowchart for a transmission-side operation state change process performed by management apparatus 1 according to the embodiment. The process shown in FIG. 6 is performed by the processing units of facility device management unit 111, Web server unit 112 and Web content display control unit 113 included in controller 11 of management apparatus 1. In FIG. 6, “S” is used as an abbreviation for “STEP”.

As shown in FIG. 6, controller 11 determines whether the operation state of facility device 2 has changed (S31). Specifically, when a temperature setting or the like of the air conditioner has been changed using a not-shown remote controller and the operation state has thereby changed, facility device 2 transmits, to management apparatus 1, a command indicating that the operation state has changed. Controller 11 determines whether the operation state of facility device 2 has changed, based on whether controller 11 has received, from facility device 2, the command indicating that the operation state has changed.

When the operation state of facility device 2 has not changed (NO in S31), controller 11 ends this process. When the operation state of facility device 2 has changed (YES in S31), controller 11 updates current operation data 172 stored in storage device 12 in accordance with the changed operation state (S32).

Controller 11 determines whether controller 11 is being connected to other management apparatus 1 using the WebSocket system (S33). When controller 11 is not being connected to other management apparatus 1 (NO in S33), controller 11 ends this process. When controller 11 is being connected to other management apparatus 1 (YES in S33), controller 11 transmits, to other management apparatus 1 that is being connected, a state change command indicating that the operation state of facility device 2 managed by management apparatus 1 has changed, and ends this process. Controller 11 may transmit updated current operation data 172 to other management apparatus 1 as the state change command.

As described above, management apparatus 1 can notify other management apparatus 1 that the operation state of facility device 2 has changed.

FIG. 6 shows the process when management apparatus 1 notifies other management apparatus 1 that the operation state of facility device 2 has changed. However, the process shown in FIG. 6 is also applied to a process when the operation state of facility device 2 managed by other management apparatus 1 has changed and other management apparatus 1 notifies management apparatus 1 that the operation state of facility device 2 has changed.

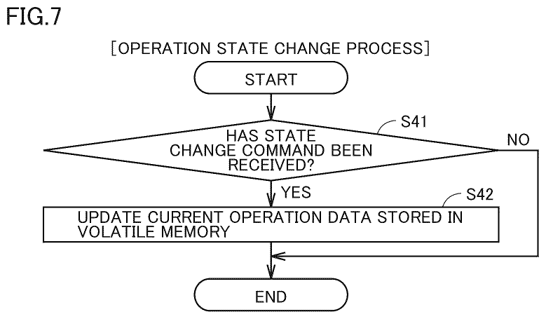

Next, a process when management apparatus 1 is notified by other management apparatus 1 that the operation state of facility device 2 has changed will be described. FIG. 7 is a flowchart for a reception-side operation state change process performed by management apparatus 1 according to the embodiment. The process shown in FIG. 7 is performed by the processing units of facility device management unit 111, Web server unit 112 and Web content display control unit 113 included in controller 11 of management apparatus 1. In FIG. 7, “S” is used as an abbreviation for “STEP”.

As shown in FIG. 7, controller 11 determines whether controller 11 has received the state change command from other management apparatus 1 (S41). When controller 11 has not received the state change command from other management apparatus 1 (NO in S41), controller 11 ends this process. When controller 11 has received the state change command from other management apparatus 1 (YES in S41), controller 11 updates current operation data 172 of other management apparatus 1 temporarily stored in volatile memory 114 based on the state change command (S42) and ends this process. When controller 11 has received updated current operation data 172 from other management apparatus 1 as the state change command, controller 11 may store received updated current operation data 172 in volatile memory 114.

As described above, management apparatus 1 can receive, from other management apparatus 1, the state change command indicating that the operation state of facility device 2 managed by other management apparatus 1 has changed, and update current operation data 172 obtained from other management apparatus 1. Management apparatus 1 can thus cause display 15 to display updated current operation data 172.

FIG. 7 shows the process when management apparatus 1 is notified by other management apparatus 1 that the operation state of facility device 2 has changed. However, the process shown in FIG. 7 is also applied to a process when other management apparatus 1 is notified by management apparatus 1 that the operation state of facility device 2 has changed.

In addition, in the processes shown in FIGS. 6 and 7, controller 11 updates current operation data 172. However, the processes shown in FIGS. 6 and 7 are also applicable to a case in which controller 11 updates past operation data 173 or history data 174, similarly to current operation data 172.

### [Past Operation Data Viewing Process]

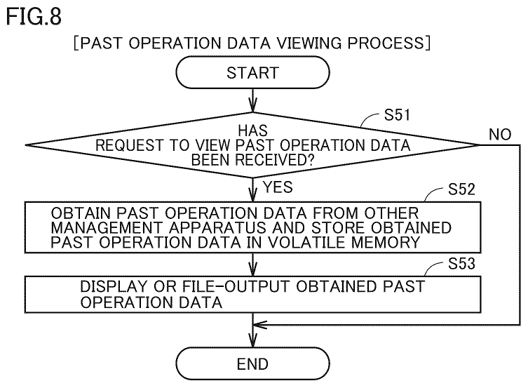

FIG. 8 is a flowchart for a past operation data viewing process performed by management apparatus 1 according to the embodiment. The process shown in FIG. 8 is performed by the processing units of facility device management unit 111, Web server unit 112 and Web content display control unit 113 included in controller 11 of management apparatus 1. In FIG. 8, “S” is used as an abbreviation for “STEP”.

As shown in FIG. 8, controller 11 determines whether controller 11 has received a request to view past operation data 173 (S51). Specifically, controller 11 determines whether a viewing command to view past operation data 173 has been input by the user using input device 16. When controller 11 has not received the request to view past operation data 173 (NO in S51), controller 11 ends this process.

When controller 11 has received the request to view past operation data 173 (YES in S51), controller 11 requests, for other management apparatus 1, past operation data 173 in a time period specified by the viewing command from the user, obtains past operation data 173 from other management apparatus 1, and stores obtained past operation data 173 in volatile memory 114 (S52).

Controller 11 causes display 15 to display past operation data 173 of other management apparatus 1 stored in volatile memory 114, or outputs and saves past operation data 173 in the file format (S53). Thereafter, controller 11 ends this process.

As described above, management apparatus 1 can obtain past operation data 173 of facility device 2 managed by other management apparatus 1 from other management apparatus 1 in response to the viewing command from the user, and cause display 15 to display obtained past operation data 173, or save obtained past operation data 173 in the file format.

In the past operation data viewing process shown in FIG. 8, controller 11 obtains past operation data 173 in response to the viewing command from the user. However, the process shown in FIG. 8 is also applicable to a case in which controller 11 obtains history data 174 in response to the viewing command from the user, similarly to past operation data 173.

### [Address List Change Process]

As described above, controller 11 of management apparatus 1 can specify the communication destination and communicate with other management apparatus 1, based on the address information included in address list 191 stored in storage device 12. However, when address list 191 is changed, controller 11 of management apparatus 1 can change the communication destination based on changed address list 191, thereby changing facility device data 17, 175 to be displayed on display 15.

Address list 191 may be changed based on a command to change address list 191, which is input by the user using input device 16, or may be changed based on a command to change address list 191, which is input by the user using a general-purpose computer such as a PC that can communicate with management apparatus 1.

Management apparatus 1 can thus obtain facility device data 175 from other management apparatus 1 desired by the user, based on address list 191 changed by the user, and cause display 15 to display obtained facility device data 175.

### [Monitoring Process by Monitoring Apparatus]

Although not shown, monitoring apparatus 3 may include the same Web content 18 as Web content 18 included in management apparatus 1. By loading Web content 18 with the Web browser, monitoring apparatus 3 may obtain facility device data 17 from each of management apparatuses 1 connected by communication line 5, and display the monitoring screen for viewing facility device data 17 of facility device 2 or operating facility device 2. Monitoring apparatus 3 is not limited to a PC of the manager of the building where facility device 2 is placed, but may be a PC (e.g., a mobile terminal) owned by the user located at a position different from that of the building.

### Modifications

The present disclosure is not limited to the above-described examples, and various modifications and applications are further possible. Modifications applicable to the present disclosure will be described below.

Management apparatus 1 is not limited to the configuration in which Web content display control unit 113 and Web server unit 112 are constantly connected using the WebSocket system, but may be configured such that Web content display control unit 113 and Web server unit 112 are connected using the HTTP protocol, a dedicated protocol or the like.

Management apparatus 1 is not limited to the configuration in which management apparatus 1 is constantly connected to other management apparatus 1 using the WebSocket system, but may be configured such that management apparatus 1 is connected to other management apparatus 1 using the HTTP protocol, a dedicated protocol or the like.

Management system 100 is not limited to the system in which facility device data 17 is received and transmitted among the plurality of management apparatuses 1 arranged in the same building, but is also applicable to a system in which facility device data 17 is received and transmitted among a plurality of management apparatuses 1 arranged in a plurality of geographically separated buildings.

As the format of communication between management apparatus 1 and other management apparatus 1, a text format using an extensible markup language (XML) or the like may be used, or another format such as a binary format may be used to reduce the communication size. Furthermore, the communication data may be encrypted such that the information such as facility device data 17 received and transmitted between management apparatus 1 and other management apparatus 1 can be concealed.

Web content 18 and system configuration data 19 of management apparatus 1 may be arranged in a server such as a cloud on the Internet in a synchronized manner. By doing so, the monitoring screen displayed on the same display 15 can be viewed not only through display 15 of management apparatus 1 but also through another PC (e.g., a mobile terminal) over the Internet.

In management apparatus 1, Web content display control unit 113 causes display 15 to display the monitoring screen by using Web content 18 stored in management apparatus 1. Therefore, the monitoring screen does not need to include a menu screen such as a “Back” button or a “Save” button, as in a screen displayed on a general-purpose Web browser. By doing so, management apparatus 1 can prevent unauthorized viewing of the setting information using the “Back” button, unauthorized rewriting of an internal file, and the like in the monitoring screen, which can result in prevention of security vulnerability.

### SUMMARY

The present disclosure provides management apparatus 1 that manages facility device 2. Management apparatus 1 includes: display 15; controller 11 configured to control display 15; and address list 191 including address information of further management apparatus 1 different from management apparatus 1. Controller 11 is configured to: communicate with further management apparatus 1 based on address list 191, to obtain facility device data 175 about facility device 2 managed by further management apparatus 1; and cause display 15 to display facility device data 175.

With such a configuration, management apparatus 1 can obtain facility device data 175 from other management apparatus 1 based on address list 191, and cause display 15 to display facility device data 175. Therefore, each management apparatus 1 can obtain facility device data 175 from other management apparatus 1 using address list 191 held by management apparatus 1 itself. Thus, management apparatus 1 and other management apparatus 1 no longer have the master-slave relationship, and each management apparatus 1 can freely select facility device 2 managed by other management apparatus 1, i.e., facility device 2 to be monitored by each management apparatus, and monitor facility device 2 managed by other management apparatus 1. Therefore, management apparatus 1 can monitor the facility device managed by other management apparatus 1, without considering the limitations on the number of connectable management apparatuses 1.

For example, in an example in which two management apparatuses 1 are placed in each floor and three management apparatuses 1 are placed in the manager's room, the user can monitor other management apparatus 1 placed in the same floor or another floor, using any one of two management apparatuses 1 placed in each floor, which leads to improvement in user convenience. In addition, the manager can monitor all of management apparatuses 1 placed in the respective floors, using any one of three management apparatuses 1 placed in the manager's room, which can lead to reduction in management workload of the manager.

For example, when one management apparatus 1 including display 15 is placed in each floor and the manager's room, the user can cause display 15 to display facility device data 175 about facility device 2 managed by other management apparatus 1, using management apparatus 1 including display 15, even if other management apparatus 1 does not include display 15. Therefore, management apparatus 1 used by the user may only be equipped with display 15, which can lead to reduction in cost of management system 100 as a whole.

Management apparatus 1 further includes input device 16 configured to receive a user's input. Controller 11 is configured to communicate with further management apparatus 1 based on address list 191 and control facility device 2 managed by further management apparatus 1 based on the user's input received by input device 16.

With such a configuration, management apparatus 1 can freely select facility device 2 managed by other management apparatus 1, based on address list 191, and control facility device 2 managed by other management apparatus 1.

Controller 11 is configured to cause, by loading Web content 18 with a Web browser, display 15 to display an image indicating facility device data 175.

With such a configuration, management apparatus 1 can cause display 15 to display the image indicating facility device data 175, using the Web browser.

Management apparatus 1 further includes storage device 12 serving as a non-volatile memory and volatile memory 114. Facility device data 17 about facility device 2 managed by management apparatus 1 is stored in storage device 12. Facility device data 175 about facility device 2 managed by further management apparatus 1 is stored in volatile memory 114.

With such a configuration, management apparatus 1 itself does not need to store and hold facility device data 175 about facility device 2 managed by other management apparatus 1 in non-volatile storage device 12. Therefore, a shortage of the memory capacity of storage device 12 can be avoided and there is no need to consider the limitations on the number of connectable management apparatuses 1.

In addition to the address information of further management apparatus 1, self address information of management apparatus 1 itself is includable in address list 191. Controller 11 is configured to: cause display 15 to display facility device data 17 about facility device 2 managed by management apparatus 1, when the self address information is included in address list 191; and cause display 15 not to display facility device data 17 about facility device 2 managed by management apparatus 1, when the self address information is not included in address list 191.

With such a configuration, management apparatus 1 can select whether to cause display 15 to display facility device data 17 about facility device 2 managed by management apparatus 1 itself, based on whether the address information of management apparatus 1 itself is included in address list 191. In addition, when the address information of management apparatus 1 itself is included in address list 191, management apparatus 1 must be connected to facility device 2 through communication line 4. However, when the address information of management apparatus 1 itself may not be included in address list 191, management apparatus 1 can monitor and control facility device 2 managed by other management apparatus 1, simply by connecting to communication line 5 without connecting to communication line 4. Therefore, the placement location for management apparatus 1 is less likely to be limited and the placement location can be freely determined. For example, by placing additional management apparatus 1 at a doorway of a floor, user convenience can be improved. By placing management apparatus 1 in the manager's room without the need for wiring for air conditioning (M-NET) from a rooftop, the construction cost can be reduced. In a university or the like including a plurality of buildings, management apparatus 1 placed in one building can monitor facility device 2 placed in another building, and thus, expandability can be ensured. Furthermore, when an abnormality or the like occurs in facility device 2 in another building, a monitoring screen for monitoring facility device 2 in the other building can be displayed.

When address list 191 is changed, controller 11 is configured to change a communication destination based on changed address list 191, thereby changing facility device data 175 displayed on display 15.

With such a configuration, management apparatus 1 can obtain facility device data 175 from other management apparatus 1 desired by the user, based on changed address list 191, and cause display 15 to display obtained facility device data 175.

Management apparatus 1 is connectable to monitoring apparatus 3, and using Web content 18 used by controller 11, monitoring apparatus 3 is configured to display an image indicating facility device data 17, 175.

With such a configuration, monitoring apparatus 3 can display the same monitoring screen as that of management apparatus 1 using the same Web content 18 as that of management apparatus 1, which can lead to improvement in user convenience. In addition, there is no need to develop both a display program in management apparatus 1 and a monitoring program in monitoring apparatus 3, which can lead to reduction in development cost.

Controller 11 is constantly connected to further management apparatus 1 by bidirectional communication based on address list 191.

With such a configuration, management apparatus 1 can be constantly connected to other management apparatus 1 by bidirectional communication. Therefore, data transmission can be started from any of management apparatus 1 and other management apparatus 1.

When controller 11 receives a state change command indicating that an operation state of facility device 2 managed by further management apparatus 1 has changed, controller 11 is configured to update obtained facility device data 175 based on the state change command.

With such a configuration, management apparatus 1 can cause display 15 to display updated facility device data 175 in response to the change in the operation state of facility device 2 managed by other management apparatus 1.

Management apparatus 1 and other management apparatus 1 hold a common first certificate (root certificate), management apparatus 1 and other management apparatus 1 hold a second certificate (intermediate root certificate) and a third certificate (server certificate) different from each other, and controller 11 is configured to communicate with other management apparatus 1 on the condition that the second certificate (intermediate root certificate) and the third certificate (server certificate) held by other management apparatus 1 are generated using the first certificate (root certificate).

With such a configuration, simply by holding the common first certificate (root certificate), management apparatus 1 can prevent connection destination spoofing and the like, and can achieve communication connection with the ensured security.

The present disclosure provides a control method for management apparatus 1 that manages facility device 2. The control method includes: communicating with further management apparatus 1 different from management apparatus 1 based on address list 191 including address information of further management apparatus 1, to obtain facility device data 175 about facility device 2 managed by further management apparatus 1 (S22); and causing display 15 of management apparatus 1 to display facility device data 175 (S24).

With such a configuration, each management apparatus 1 can obtain facility device data 175 from other management apparatus 1 using address list 191 held by management apparatus 1 itself. Thus, management apparatus 1 and other management apparatus 1 no longer have the master-slave relationship, and each management apparatus 1 can freely select facility device 2 managed by other management apparatus 1, i.e., facility device 2 to be monitored by each management apparatus, which can be monitored in each management apparatus 1, and monitor facility device 2 managed by other management apparatus 1. Therefore, management apparatus 1 can monitor the facility device managed by other management apparatus 1, without considering the limitations on the number of connectable management apparatuses 1.

It should be understood that the embodiments disclosed herein are illustrative and non-restrictive in every respect. The scope of the present disclosure is defined by the terms of the claims, rather than the description of the embodiments above, and is intended to include any modifications within the scope and meaning equivalent to the terms of the claims.

### REFERENCE SIGNS LIST

1, 1A, 1B, 1C management apparatus; 2, 21A, 21B, 21C, 22A, 22B, 22C, 23A, 23B, 23C facility device; 3 monitoring apparatus; 4, 4A, 4B, 4C, 5 communication line; 11 controller; 12 storage device; 13 facility device interface; 14 other apparatus interface; 15 display; 16 input device; 17, 175 facility device data; 18 Web content; 19 system configuration data; 100 management system; 111 facility device management unit; 112 server unit; 113 content display control unit; 114 volatile memory; 171 connection information; 172 current operation data; 173 past operation data; 174 history data; 181 screen configuration file; 182 monitoring program; 191 address list; 1131 screen configuration file analysis unit; 1132 monitoring program execution unit; 1821 management apparatus communication unit; 1822 facility device communication unit.

1. A management apparatus that manages a facility device, the management apparatus comprising:
a display;
a controller configured to control the display; and
an address list including address information of a further management apparatus different from the management apparatus, wherein
the controller is configured to:
communicate with the further management apparatus based on the address list, to obtain facility device data about the facility device managed by the further management apparatus; and
cause the display to display the facility device data.

2. The management apparatus according to claim 1, further comprising
an input device configured to receive a user's input, wherein
the controller is configured to communicate with the further management apparatus based on the address list and control the facility device managed by the further management apparatus based on the user's input received by the input device.

3. The management apparatus according to claim 1, wherein
the controller is configured to cause, by loading a Web content with a Web browser, the display to display an image indicating the facility device data.

4. The management apparatus according to claim 1, further comprising
a non-volatile memory and a volatile memory, wherein
the facility device data about the facility device managed by the management apparatus is stored in the non-volatile memory, and
the facility device data about the facility device managed by the further management apparatus is stored in the volatile memory.

5. The management apparatus according to claim 1, wherein
in addition to the address information of the further management apparatus, self address information of the management apparatus itself is includable in the address list, and
the controller is configured to:
cause the display to display the facility device data about the facility device managed by the management apparatus, when the self address information is included in the address list; and
cause the display not to display the facility device data about the facility device managed by the management apparatus, when the self address information is not included in the address list.

6. The management apparatus according to claim 1, wherein
when the address list is changed, the controller is configured to change a communication destination based on the changed address list, thereby changing the facility device data displayed on the display.

7. The management apparatus according to claim 3, wherein
the management apparatus is connectable to a monitoring apparatus, and
using the Web content used by the controller, the monitoring apparatus is configured to display an image indicating the facility device data.

8. The management apparatus according to claim 1, wherein
the controller is constantly connected to the further management apparatus by bidirectional communication based on the address list.

9. The management apparatus according to claim 1, wherein
when the controller receives a state change command indicating that an operation state of the facility device managed by the further management apparatus has changed, the controller is configured to update the obtained facility device data based on the state change command.

10. The management apparatus according to claim 1, wherein
the management apparatus and the further management apparatus hold a common certificate,
the management apparatus and the further management apparatus hold self certificates different from each other, and
the controller is configured to communicate with the further management apparatus on the condition that the self certificates held by the further management apparatus are generated using the common certificate.

11. A control method for a management apparatus that manages a facility device, the control method comprising:
communicating with a further management apparatus different from the management apparatus based on an address list including address information of the further management apparatus, to obtain facility device data about the facility device managed by the further management apparatus; and
causing a display of the management apparatus to display the facility device data.
